(19) United States
(12) Patent Application Publication
(10) Pub. No.: US 2014/0314166 A1
(43) Pub. Date: Oct. 23, 2014

(54) Adaptive Signaling and Feedback for Multi-User Multiple input Multiple output (MU-MIMO)

(71) Applicant: Broadcom Corporation, Irvine, CA (US)

(72) Inventors: Krishna GOMADAM, San Jose, CA (US); Djordje TUJKOVIC, Mountain View, CA (US)

(21) Appl. No.: 14/256,712

(22) Filed: Apr. 18, 2014

Related U.S. Application Data
(60) Provisional application No. 61/814,559, filed on Apr. 22, 2013.

(51) Int. Cl. H04B 7/04

(52) U.S. Cl. CPC H04B 7/0417; H04B 7/0452; H04B 7/0482
USPC 375/267

(57) ABSTRACT

Embodiments recognize that Multi-User Multiple Input Multiple Output (MU-MIMO) performance can be greatly enhanced if additional parameters are provided to the User Equipment (UE) during link adaptation and/or data demodulation. Recognizing the overhead that such signaling entails, embodiments provide MU-MIMO enhancement solutions that identify and signal only those parameters that can result in a large gain improvement when known at the UE. In an embodiment, the signaling rate of information can be adapted to channel and deployment conditions. In another embodiment, different parameters, which can vary according to different time scales, are signaled at different rates to the UE.

### CROSS-REFERENCE TO RELATED APPLICATION(S)

The present application claims the benefit of U.S. Provisional Application No. 61/814,559, filed Apr. 22, 2013, which is incorporated herein by reference in its entirety.

### TECHNICAL FIELD

The present disclosure relates generally to enhancing Multi-User Multiple Input Multiple Output (MU-MIMO) wireless communication.

### BACKGROUND

### Background Art

In Multi-User Multiple Input Multiple Output (MU-MIMO), a base station utilizes multiple transmit antennas to service a plurality of User Equipments (UEs) on the same time and frequency resources. To reduce interference between the multiple transmitted data streams, the base station pre-codes the data streams before transmission to create spatially orthogonal paths from the base station to the various UEs served by the MU-MIMO data transmission.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIGS. 1A-B illustrate an example environment in which embodiments can be implemented or practiced.

FIGS. 2-5 illustrate example processes according to embodiments.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

For purposes of this discussion, the term “module” shall be understood to include at least one of software, firmware, and hardware (such as one or more circuits, microchips, processors, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

For the purposes of this discussion, the term “processor circuitry” shall be understood to include one or more: circuit(s), processor(s), or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to embodiments described herein. Alternatively, the processor can access an internal or external memory to retrieve instructions stored in the memory, which when executed by the processor, perform the corresponding function(s) associated with the processor.

In the following disclosure, terms defined by the Long-Term Evolution (LTE) standard are sometimes used. For example, the term “eNodeB” or “eNB” is used to refer to what is commonly described as base station (BS) or base transceiver station (BTS) in other standards. The term “User Equipment (UE)” is used to refer to what is commonly described as a mobile station (MS) or mobile terminal in other standards. However, as will be apparent to a person of skill in the art based on the teachings herein, embodiments are not limited to the LTE standard and can be applied to other wireless communication standards, including, without limitation, WiMAX, WCDMA, WLAN, and Bluetooth. As such, according to embodiments, an eNB in the disclosure herein can more generally be an Access Point (AP), where the AP encompasses APs (e.g., WLAN AP, Bluetooth AP, etc), base stations, or other network entities that terminate the air interface with the mobile terminal.

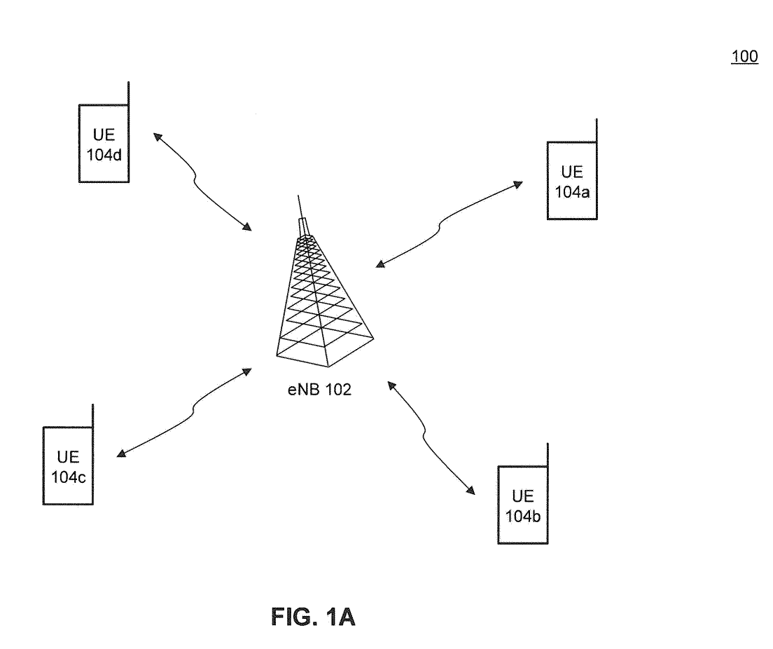

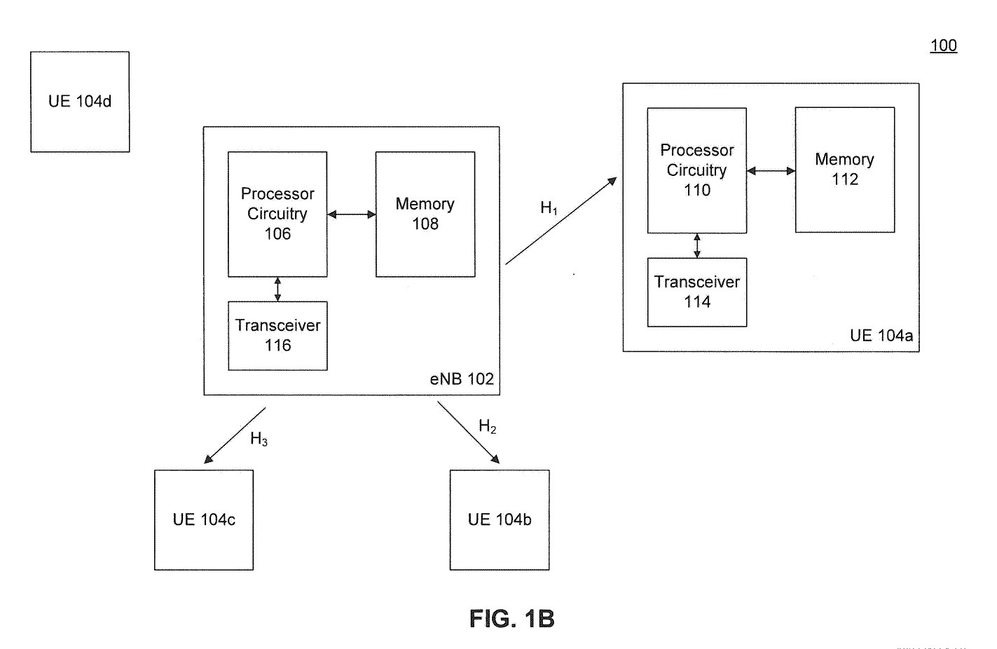

FIGS. 1A-B illustrate an example environment 100 according to which embodiments can be implemented or practiced. Example environment 100 is provided for the purpose of illustration only and is not limiting of embodiments. As shown in FIG. 1A, example environment 100 includes an Evolved Node B (eNB) 102 and a plurality of user equipments (UEs) 104a, 104b, 104c, and 104d. For the purpose of this discussion, it is assumed that UEs 104a, 104b, 104c, and 104d are within wireless service range of eNB 102.

In an embodiment, as shown in FIG. 1B, eNB 102 includes, without limitation, processor circuitry 106, a memory 108, and a transceiver 116. Memory 108 stores instructions that when executed by processor circuitry 106 enable eNB 102 to perform the functionalities described herein. Transceiver 116 includes transmit and receive circuitry that allow eNB 102 to communicate wirelessly with UEs, such as UEs 104a, 104b, 104c, and 104d. Similarly, UEs 104a, 104b, and 104c, and 104d can each include, without limitation, processor circuitry 110, a memory 112, and a transceiver 114. Memory 112 stores instructions that when executed by processor circuitry 110 enable UE 104 to perform the functionalities described herein. Transceiver 114 includes transmit and receive circuitry that allow the UE to communicate wirelessly with an eNB, such as eNB 102.

In an embodiment, eNB 102 includes a plurality of transmit antennas (e.g., 4, 8, etc.) (not shown in FIG. 1B), which it can use simultaneously to service one or more of UEs 104a, 104b, 104c, and 104d. In one embodiment, eNB 102 can use the plurality of transmit antennas simultaneously to service a single one of UEs 104a, 104b, 104c, and 104d. This transmission mode, known as Single-User Multiple Input Multiple Output (SU-MIMO), involves simultaneous transmission of a data stream from multiple antennas on the same frequency resources, to achieve a beamforming effect to the intended UE recipient.

In another embodiment, eNB 102 can utilize the plurality of transmit antennas to service a plurality of UEs 104a, 104b, 104c, and 104d on the same time and frequency resources, a transmission mode known as Multi-User Multiple Input Multiple Output (MU-MEMO). For example, eNB 102 can transmit dedicated data streams (also referred to as “layers”) on the same time and frequency resources to UEs 104a, 104b, and 104c. In an embodiment, the data streams are pre-coded (by multiplication with a transmit precoding matrix ν) before transmission such that the effective downlink channel (H.ν, where H=[H1 H2 H3] represents the downlink channel) from eNB 102 to UEs 104a, 104b, and 104c includes spatially orthogonal (or substantially orthogonal) paths. As a result, the data streams can be transmitted on the same time and frequency resources to their respective intended UE recipients with no or minimal interference to each other. In another embodiment, the data streams can be pre-coded such that each of the data streams is beamformed to its intended UE recipient.

By exploiting the spatial multiplexing gain of the network environment as described above, MU-MIMO can result in a high spectral efficiency. MU-MIMO is also attractive to network operators from a fairness perspective as UEs can be allocated resources with lower delay compared to SU-MIMO. However, unlike SU-MIMO, the achievable gain of MU-MIMO in conventional systems depends on several factors.

For instance, the achievable gain of MU-MIMO can be sensitive to the load in the network (e.g., the number of ‘data-ready’ UEs in the network that the eNB can select from for MU-MIMO data transmission) and the size of the MU-MIMO group. Moreover, the gain can depend on the correlation of the Precoding Matrix Indicators (PMIs) (which form the transmit precoding matrix ν) used for the MU-MIMO group (e.g., the amount of spatial separation between the paths of the pre-coded downlink channel depends on the correlation of the PMIs) and the granularity of the codebook from which the PMIs can be chosen (or any configured codebook subset restriction that limits PMI choice). Further, the MU-MIMO gain can be sensitive to the modulations schemes used for the MU-MIMO group members (e.g., some modulation schemes result in Gaussian-like noise that is harder to remove at a non-intended UE) as well as the accuracy of the UE predicted Channel Quality Indicators (CQIs) (which are determined and reported by the UEs to the eNB during link adaptation and on the basis of which the modulation schemes are chosen by the eNB).

The sensitivity of the MU-MIMO achievable gain to the above described factors is mainly due to the UE's lack of knowledge about co-scheduled UEs during both link adaptation and data demodulation in conventional MU-MIMO. Specifically, during link adaptation, the UE assumes an input-output relationship that can be described mathematically by:

y=Hxₚ+n (1)

where y represents a received signal, H represents the downlink channel from the eNB to the UE (which can be measured by the UE on Channel State Information-Reference Signal (CSI-RS) resources of the Physical Downlink Shared Channel (PDSCH)), xₚ represents a data symbol, and n represents noise (which can be measured by the UE on an Interference Management Resource (IMR) or a Cell-Specific Reference Signal (CRS) resource of the PDSCH depending on the transmission mode).

Based on the above input-output model assumption, the UE computes an estimate of the downlink channel H from the eNB, and uses the channel estimate to select a PMI and a CQI (which identify respectively a transmit precoder and a Modulation and Coding Scheme (MCS) to be used by the eNB in transmitting to the UE). For example, the UE can select a PMI/CQI combination that provides a desired capacity (e.g., data rate) of the channel (while satisfying a pre-defined error rate). The UE signals the selected PMI and CQI to the eNB, which adapts the link to the UE according to the reported PMI and CQI.

However, the above model assumption is sub-optimal for MU-MIMO because it assumes the same interference conditions for data demodulation as for link adaptation, something which may be true for SU-MIMO but not for MU-MIMO. More specifically, while the model assumes equation (I) above, in reality, during MU-MIMO data transmission, the received signal at a UE (for any subband ‘f’) can be written mathematically as:

$$\begin{matrix}y = \sqrt{{P}_{1}} {Hv}_{1} {x}_{1} + {\sum }_{k = rank ( {x}_{1} ) + 1}^{MUrank} \sqrt{{P}_{k}} {Hv}_{k} {x}_{k} + n \\ = \sqrt{{P}_{1}} {h}_{1} {x}_{1} + {\sum }_{k = rank ( {x}_{1} ) + 1}^{Murank} \sqrt{{P}_{k}} {h}_{k} {x}_{k} + n\end{matrix} \qquad ( 2 )$$

where x₁ represents a data symbol of a data stream for the UE (or multiple symbols of multiple respective data streams for the UE when the UE has a rank greater than 1), xₖ represents a data symbol of a data stream for another UE of the MU-MIMO group, v₁ represents a transmit precoder vector (or matrix when the UE has rank greater than 1) used to pre-code x₁, vₖ represents a transmit precoder vector used to pre-code xₖ, H represents the downlink channel from the eNB to the UE, h₁ and hₖ represent the effective downlink channels for x₁ and xₖ, P₁ represents a relative transmit power of x₁, Pk represents a relative transmit power of xₖ, rank(x₁) represents the rank of the UE (the number of data streams for the UE in the MU-MIMO data transmission), MUrank represents the total rank of the MU-MIMO data transmission (total number of data streams in the MU-MIMO data transmission), and n represents noise.

In other words, conventional link adaptation fails to account for intra-cell interference (interference due to data streams intended for other UEs in a MU-MIMO data transmission) that can occur during actual MU-MIMO data transmission. No information is provided to the UE by the network regarding intra-cell interference, and the UE uses a link adaptation process tailored for single user transmission. As a result, the PMI and CQI which result from the link adaptation process can be sub-optimal for subsequent data demodulation.

Table 1 below describes parameters that are provided to the UE in current LTE releases during link adaptation and data demodulation. As shown, the only parameter that is explicitly provided to the UE is the UE's own modulation scheme, which is signaled prior to data demodulation. While some of the parameters can be estimated during data demodulation, none of the parameters, which affect the achievable MU-MIMO gain as described above, are given to the UE during link adaptation.

TABLE 1

| | | Known | |
|---|---|---|---|
| | Value | during Link | Known during Data |
| Variables | Ranges | Adaptation? | Demodulation ? |
| MUrank | 1 . . . 4 | No | No, but can be estimated to |
| | | | some extent |
| hₗ, i = 2 . . . 4 | Nᵣ × 1 | No | No, but can be estimated |
| | complex | | conditioned on MUrank |
| | vector space | | |
| \sqrt{Pₖ} | Real Scalar | No | Implicitly derived from |
| | | | channel estimation |
| Modulation | 1 . . . 3 | No | Yes |
| scheme of xₗ | | | |
| Modulation | 1 . . . 3 | No | No, but can be determined |
| scheme of | | | probabilistically |
| xₖ, k = 2 . . . 4 | | | |

Embodiments, as further described below, recognize that MU-MIMO performance can be greatly enhanced if additional parameters are provided to the UE during link adaptation and/or data demodulation. For example, information can be provided during link adaptation and the UE can be relied on to estimate parameters during data demodulation, or vice versa. Alternatively, information is provided during both link adaptation and data demodulation. Recognizing the overhead that such signaling entails, embodiments provide MU-MIMO enhancement solutions that identify and signal only those parameters that can result in a large gain improvement when known at the UE. In an embodiment, the signaling rate of information can be adapted to channel and deployment conditions. In another embodiment, different parameters, which can vary according to different time scales, are signaled at different rates to the UE.

In one embodiment, link adaptation parameters are signaled to the UE as an MU-MIMO parameter set for link adaptation. In an embodiment, the MU-MIMO parameter set is signaled to the UE when configuring the UE for a new (assisted MU-MIMO) transmission mode (e.g., TM 11). Alternatively, the MU-MIMO parameter set can be signaled to the UE when configuring the UE for an existing transmission mode, modified for MU-MIMO. In another embodiment, the link adaptation parameters can be configured per CSI-process. For example, as shown in Table 2 below, when a CSI-process is configured, the CSI mode (MU-MIMO or SU-MIMO) is indicated. MU-MIMO parameter set configuration can be done dynamically, semi-statically, or statically. In another embodiment, indication is also provided as to whether the parameters apply to a particular sub-band or are for wideband use.

TABLE 2
CSI Process Configuration

| | |
|---|---|
| MU-MIMO Optimized CSI | ON or OFF |
| MU-MIMO Link Adaptation | Link Adaptation Structure (e.g., as |
| Parameters | described in Table 3) |

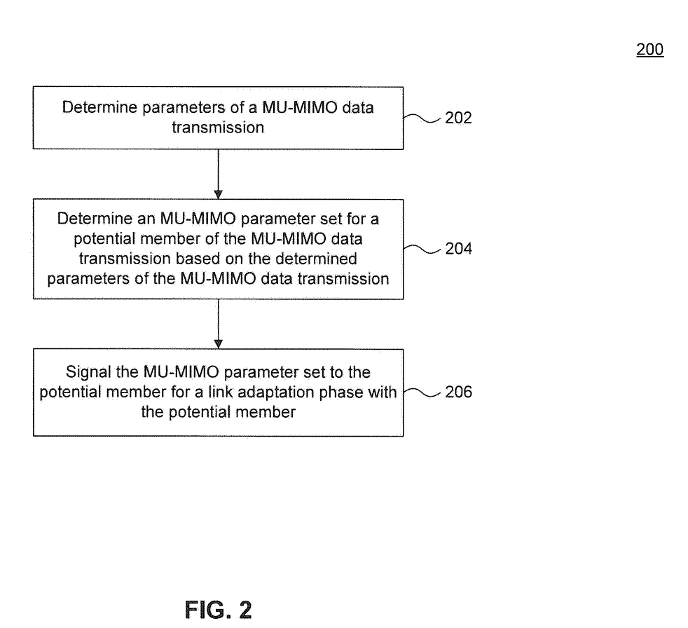

FIG. 2 illustrates an example process 200 according to an embodiment. Example process 200 is provided for the purpose of illustration only and is not limiting of embodiments. Example process 200 can be performed by an eNB, such as eNB 102, to configure a UE, such as UE 104a, with an MU-MIMO parameter set. For example, steps of process 200 can be performed by processor circuitry 106.

As shown in FIG. 2, example process 200 begins in step 202, which includes determining parameters of a (future) MU-MIMO data transmission. In an embodiment, step 202 includes determining a total transmission rank, a per member rank constraint (e.g., maximum data streams per UE in the MU-MIMO data transmission), or a power allocation of data streams of the MU-MIMO data transmission (the power allocation can be given by the values of P₁, . . . , Pₖ described in equation (2) above). For example, the eNB may determine that the MU-MIMO data transmission will include 3 data streams and that no member of the MU-MIMO group should have more than one data stream. In an embodiment, the eNB makes this determination based on the load of the network (e.g., the number of ‘data-ready’ UEs in the network that the eNB can select from for MU-MIMO data transmission).

Once the eNB determines the parameters of the MU-MIMO data transmission, the eNB must determine the members of the MU-MIMO group that will be served by the MU-MIMO data transmission. The eNB can select the MU-MIMO group to achieve various performance objectives. For example, the eNB can select the MU-MIMO group to reduce (or minimize) interference between members of the group. Alternatively, or additionally, the eNB can select the MU-MIMO group to increase (or maximize) overall channel capacity. For example, referring to environment 100, assuming that the MU-MIMO group is to include 3 members, then eNB 102 must determine the 3 UEs from among UEs 104a, 104b, 104c, and 104d that satisfy the desired performance objective. To select the MU-MIMO group, the eNB performs link adaptation with available (data-ready) UEs to obtain from each UE a UE-recommended PMI and CQI. Each available UE can be a potential member of the MU-MIMO group. Based on the reported PMIs, the eNB can select the MU-MIMO group from the available UEs. For example, referring to FIG. 1A, eNB 102 may select UEs 104a, 104b, and 104c to be the members of the MU-MIMO group.

Returning to FIG. 2, when the eNB identifies a potential member of the MU-MIMO group, process 200 proceeds to step 204, which includes determining an MU-MIMO parameter set for the potential member based on the determined parameters of the MU-MIMO data transmission determined in step 202. In an embodiment, the eNB and the UE are configured with a plurality of MU-MIMO parameters, each designated by an index. As such, step 204 includes selecting the MU-MIMO parameter set from among the plurality of MU-MIMO parameter sets.

Table 3 below describes an example MU-MIMO parameter set according to an embodiment. This example is provided for the purpose of illustration only and is not limiting of embodiments. The “Total MUrank” parameter indicates a total transmission rank of the MU-MIMO data transmission (total number of data streams in the MU-MIMO data transmission). In an embodiment, the “Total MUrank” takes a value between 1 and 4, where 1 corresponds to SU-MIMO transmission.

TABLE 3

| | |
|---|---|
| MU-MIMO CQI ON | Boolean (0 or 1) |
| MU-MIMO PMI ON | Boolean (0 or 1) |
| MU-MIMO PMI Method | 1 . . . N_{PMImethods} |
| MU-MIMO CQI Method | 1 . . . N_{CQImethods} |
| Total MUrank | 1 . . . 4 |
| Power Ratio | Array of size MUrank |
| Codebook Subset Restriction for | Bitmap of size equal to Codebook |
| Interfering PMIs | Restriction for desired stream |
| Per UE Rank Constraint | {Rank 1, Rank 2, UE choice} |

The “Power Ratio” parameter, which can be provided as an array of size ‘MUrank’, indicates a power allocation of data streams of the MU-MIMO data transmission. For example, the “Power Ratio” parameter can provide the values of P₁, . . . , Pₖ described above with reference to equation (2).

The “Codebook Subset Restriction for Interfering PMIs” parameter indicates a subset of the PMI codebook that the UE should use to report its PMI. In an embodiment, the subset of the PMI codebook may be the entire codebook. In an embodiment, the parameter is provided as a bitmap of size equal to the codebook subset restriction.

The “Per UE Rank Constraint” indicates the rank that the UE should assume for the MU-MIMO data transmission. In an embodiment, the parameter can indicate a rank value (e.g., 1, 2, etc.) or that the rank is to be determined at the UE's choice.

The “MU-MIMO PMI ON” parameter can take a Boolean (0 or 1) value and indicates whether an MU-MIMO specific PMI computation is to be used by the potential member of the MU-MIMO group during link adaptation. For example, when a MU-MIMO specific PMI computation is to be used, the UE assumes a received signal model as in equation (2), for example. When the “MU-MIMO PMI ON” parameter is set to 1, the “MU-MIMO PMI Method” parameter can take a value (e.g., between 1 and N_{PMImethods}, where N_{PMImethods} represents the total number of available PMI computation methods) to indicate a PMI computation method for the MU-MIMO PMI computation. Example PMI computation methods can include, for example, a “Best Companion PMI” method and a “Worst Companion PMI” method. The “Best Companion PMI” method selects a PMI that increases or maximizes the spectral efficiency and can be suitable for high network load conditions. The “Worst Companion PMI” method selects a PMI that reduces or minimizes the spectral efficiency and can be suitable for low to medium network load conditions.

The “MU-MIMO CQI ON” parameter can take a Boolean (0 or 1) value and indicates whether an MU-MIMO specific CQI computation is to be used by the potential member of the MU-MEMO group during link adaptation. When the “MU-MIMO CQI ON” is set to 1, the “MU-MIMO CQI Method” parameter can take a value (e.g., between 1 and N_{CQImethods}, where N_{CQImethods} represents the total number of available CQI computation methods) to indicate a CQI computation method for the MU-MIMO specific CQI computation. In an embodiment, the identified CQI computation method is related to the identified PMI computation method. An example CQI computation method for the MU-MIMO CQI computation can be given be ESNR(H,w)=f(H,w,{αᵢ},ICB_{subset}), where ESNR represents the Effective Signal to Noise Ratio, H represents the downlink channel, w represents the PMI, αᵢ represents the relative power allocation, and ICB_{subset} represents the PMI codebook subset.

Returning to FIG. 2, after determining the MU-MIME parameter set for the potential member as described above, process 200 proceeds to step 206, which includes signaling the MU-MIMO parameter set to the potential member for a link adaptation phase with the potential member. In an embodiment, step 206 includes signaling an index corresponding to the determined MU-MIMO parameter set to the potential member. In an embodiment, the index is signaled in the Downlink Control Information (DCI) of the Physical Downlink Control Channel (PDCCH).

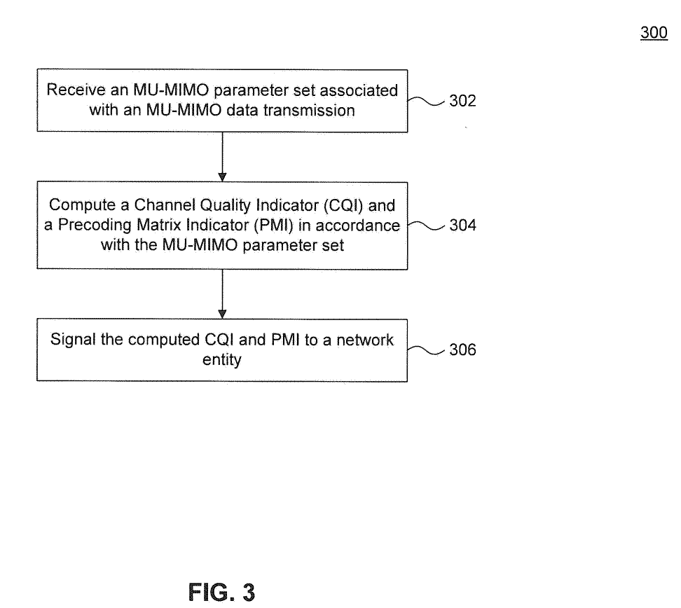

FIG. 3 illustrates another example process 300 according to an embodiment. Example process 300 is provided for the purpose of illustration only and is not limiting. Example process 300 can be performed by a UE upon receiving an MU-MIMO parameter set from an eNB. For example, steps of process 300 can be performed by processor circuitry 110 of UE 104a.

As shown in FIG. 3, example process 300 begins in step 302, which includes receiving an MU-MIMO parameter set associated with an MU-MIMO data transmission. As described above, the MU-MIMO data transmission corresponds to a future transmission by the eNB. At the time of performance of process 300, the eNB may have determined some of the parameters of the MU-MIME data transmission, but may yet to determine the full MU-MIMO group of the MU-MIMO data transmission. Process 300, which is performed at the UE, assists the eNB to determine the MU-MIMO group.

Step 304 includes computing a CQI and a PMI in accordance with the

MU-MIMO parameter set. For example, step 304 may include the UE assuming a received signal model as shown in equation (2) above to account for intra-cell interference present in MU-MIMO data transmission. Alternatively or additionally, step 304 may include computing the PMI in accordance with a MU-MIMO specific PMI computation method or a precoder codebook subset restriction indicated by the MU-MIMO parameter set and/or computing the CQI in accordance with a MU-MIMO specific CQI computation method.

Process 300 terminates in step 306, which includes signaling the computed PMI and CQI to a network entity. In an embodiment, the UE signals the PMI and CQI to the eNB. In an embodiment, step 306 can be performed by a transceiver, such as transceiver 114 of UE 104a.

In an embodiment, when the eNB receives PMIs from multiple available UEs, the eNB can use the reported PMIs to select a MU-MIMO group for the MU-MIMO data transmission. In another aspect, after selecting the MU-MIMO group, the eNB can provide dynamic indication parameters to a member of the MU-MIMO group before or during the MU-MIMO data transmission to assist the UE in data demodulation of the MU-MIMO data transmission. Table 4 below describes an example set of dynamic indication parameters according to an embodiment. This example is provided for the purpose of illustration only and is not limiting of embodiments.

TABLE 4

| | |
|---|---|
| Port Mapping of Interference | Bitmap of size 4 indicating the presence of |
| | interference in Port and SCID (Serving |
| | Cell ID) combination |
| Modulation Scheme of | {4,16,64 QAM} for each of the |
| Interference | interference layer |

The “Port Mapping of Interference” parameter indicates antenna port information for channel estimation reference signals transmitted to other members of the MU-MIMO group. In an embodiment, this parameter is provided as a bitmap of size equal to the MU-MIMO group size (e.g., 4). “The Modulation Scheme of Interference” parameter indicates modulation schemes for other members of the MU-MIMO group.

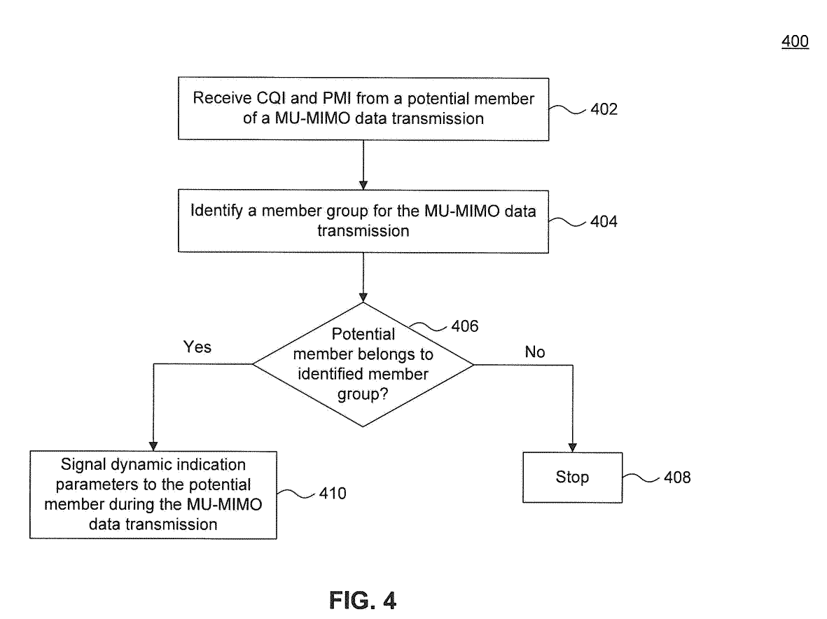

FIG. 4 illustrates another example process 400 according to an embodiment. Example process 400 is provided for the purpose of illustration only and is not limiting of embodiments. Example process 400 can be performed by an eNB, such as eNB 102, to determine whether signal dynamic indication parameters should be signaled to a UE. For example, steps of process 400 can be performed by processor circuitry 106 of eNB 102.

As shown in FIG. 4, process 400 begins in step 402, which includes receiving a CQI and a PMI from a potential member of a MU-MIMO data transmission. In an embodiment, the CQI and PMI are determined by the potential member in accordance with an MU-MIMO parameter set signaled by the eNB to the potential member.

Process 400 then proceeds to step 404, which includes identifying a member group for the MU-MIMO data transmission. The member group can include one or more UEs of available (“data-ready”) UEs in the network. Next, step 406 includes determining whether the potential member from which the CQI and the PMI were received in step 402 belongs to the identified member group for the MU-MIMO data transmission.

If the answer is no, process 400 proceeds to step 408 where it terminates. Otherwise, process 400 proceeds to step 410, which includes signaling dynamic indication parameters to the potential member during the MU-MIMO data transmission. In another embodiment, the dynamic indication parameters are signaled prior to the MU-MIMO data transmission. In an embodiment, the dynamic indication parameters are signaled in the DCI of the Physical Downlink Control Channel PDCCH. In a further embodiment, the eNB pre-configures the UE with a plurality of dynamic indication parameter sets, and signals an index corresponding to a selected dynamic indication parameter set to the UE.

In an embodiment, the dynamic indication parameters include an antenna port associated with a channel estimation reference signal of another member (or more than one member) of the identified member group. For example, referring to FIG. 1A, assuming that the MU-MIMO member group includes UEs 104a and 104b, the dynamic indication parameters signaled to UE 104a can include an antenna port (defined by specific time and frequency resources) on which a channel estimation reference signal (e.g., a pilot sequence available to UE 104a) for UE 104b is transmitted. In an embodiment, the channel estimation reference signal for UE 104b is pre-coded using the transmit precoder of UE 104b, allowing UE 104a to compute the effective downlink channel for the data stream intended for UE 104b in the MU-MIMO data transmission. Referring to equation (2), this signaling allows the UE to estimate one or more of the terms hₖ that denote the effective downlink channels for interfering data streams.

In another embodiment, the dynamic indication parameters include a modulation scheme of another member (or more than one member) of the identified member group. For example. referring to FIG. 1A, assuming that the MU-MIMO member group includes UEs 104a and 104b, the dynamic indication parameters signaled to UE 104a can include the modulation scheme for UE 104b. Knowledge of the modulation scheme allows UE 104a to better estimate or manage interference due to data streams for UE 104b (intra-cell interference due to UE 104b) in the MU-MIMO data transmission. For example, UE 104a can account for intra-cell interference due to UE 104b differently depending on the modulation scheme of UE 104b (e.g., the UE can manage QPSK modulated intra-cell interference in the same way that constant amplitude noise is managed, but 64-QAM modulated intra-cell interference can be handled like Gaussian noise). Referring to equation (2), this signaling allows the UE to estimate one or more of the terms xₖ that denote data symbols of intra-cell interference.

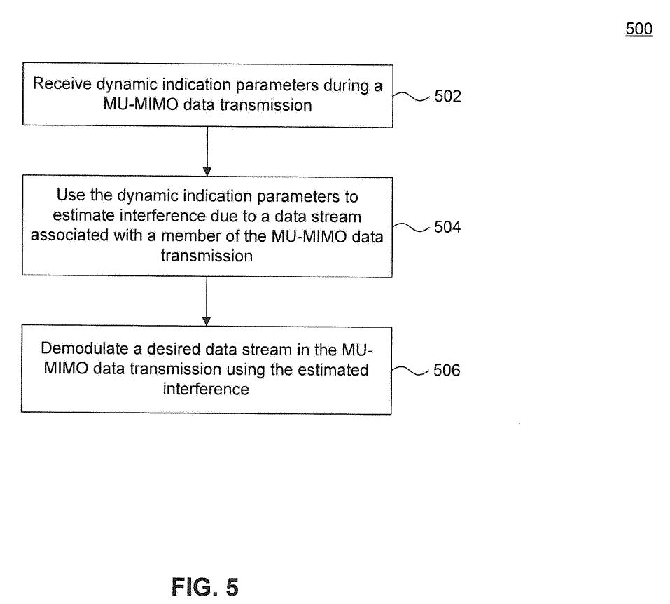

FIG. 5 illustrates another example process 500 according to an embodiment. Example process 500 is provided for the purpose of illustration only and is not limiting of embodiments. Example process 500 can be performed by a UE that receives dynamic indication parameters as described above. For example, steps of process 500 can be performed by processor circuitry 110 of UE 104a.

As shown in FIG. 5, process 500 begins in step 502, which includes receiving dynamic indication parameters during a MU-MIMO data transmission. In another embodiment, the dynamic indication parameters are received prior to the MU-MIMO data transmission. As described above, the dynamic indication parameters can be received on the DCI of the PDCCH in an embodiment. In an embodiment, step 502 includes receiving an antenna port associated with a reference signal of another member of the MU-MIMO data transmission and/or a modulation scheme used for the other member in the MU-MIMO data transmission.

Step 504 includes using the dynamic indication parameters to estimate interference due to a data stream associated with the other member (intra-cell interference due to the other member) in the MU-MIMO data transmission. In an embodiment, step 504 includes using the antenna port associated with the reference signal of the other member to estimate an effective downlink channel for the data stream associated with the other member. In another embodiment, step 504 includes using the modulation scheme of the other member to estimate data symbols of the data stream associated with the other member.

Process 500 terminates in step 506, which includes demodulating a desired data stream in the MU-MIMO data transmission using the estimate interference. In an embodiment, the UE assumes a received signal model as in equation (2), for example, to demodulate the desired data stream.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments as other embodiments will be apparent to a person of skill in the art based on the teachings herein.

What is claimed is:

1. An Access Point (AP), comprising:
a memory that stores instructions; and
processor circuitry configured, by executing the instructions, to:
determine parameters of a Multi-User Multiple Input Multiple Output (MU-MIMO) data transmission;
determine an MU-MIMO parameter set for a potential member of the MU-MIMO data transmission based on the determined parameters of the MU-MIMO data transmission; and
signal the MU-MIMO parameter set to the potential member for a link adaptation phase with the potential member.

2. The AP of claim 1, wherein the parameters of the MU-MIMO data transmission include a total transmission rank, a per member rank constraint, or a power allocation of data streams of the MU-MIMO data transmission.

3. The AP of claim 1, wherein the processor circuitry is further configured to select the MU-MIMO parameter set from among a plurality of MU-MIMO parameter sets.

4. The AP of claim 1, wherein the MU-MIMO parameter set indicates whether an MU-MIMO specific Channel Quality Indicator (CQI) computation is to be used by the potential member during the link adaptation phase.

5. The AP of claim 4, wherein the MU-MIMO parameter set indicates that the MU-MIMO specific CQI computation is to be used by the potential member during the link adaptation phase, and wherein the MU-MIMO parameter set further indicates a CQI computation method for the MU-MIMO specific CQI computation.

6. The AP of claim 1, wherein the MU-MIMO parameter set indicates whether an MU-MIMO specific Precoding Matrix Indicator (PMI) computation is to be used by the potential member during the link adaptation phase.

7. The AP of claim 6, wherein the MU-MIMO parameter set indicates that the MU-MIMO specific PMI computation is to be used by the potential member during the link adaptation phase, and wherein the MU-MIMO parameter set further indicates a PMI computation method for the MU-MIMO specific PMI computation.

8. The AP of claim 1, wherein the MU-MIMO parameter set indicates a total transmission rank, a rank for the potential member, or a power allocation of data streams of the MU-MIMO data transmission.

9. The AP of claim 1, wherein the MU-MIMO parameter set indicates a precoder codebook subset restriction for Precoding Matrix Indicator (PMI) computation by the potential member during the link adaptation phase.

10. The AP of claim 1, wherein the processor circuitry is further configured to signal an index corresponding to the MU-MIMO parameter set to the potential member.

11. The AP of claim 1, wherein the processor circuitry is further configured to:
identify a member group for the MU-MIMO data transmission; and
if the potential member belongs to the identified member group, signal to the potential member, during the MU-MIMO data transmission, an antenna port associated with a reference signal or a modulation scheme of another member of the identified member group.

12. The AP of claim 11, wherein the processor circuitry is further configured to:
pre-configure the potential member with a plurality of dynamic indication parameter sets; and
signal to the potential member an index corresponding to a selected dynamic indication parameter set of the plurality of dynamic indication parameter sets, wherein the selected dynamic indication parameter set includes the antenna port associated with the reference signal or the modulation scheme of the other member of the identified member group.

13. A method performed by an Access Point (AP), comprising:
determining parameters of a Multi-User Multiple Input Multiple Output (MU-MIMO) data transmission;
determining an MU-MIMO parameter set for a potential member of the MU-MIMO data transmission based on the determined parameters of the MU-MIMO data transmission; and
signaling the MU-MIMO parameter set to the potential member for a link adaptation phase with the potential member.

14. The method of claim 13, wherein the parameters of the MU-MIMO data transmission include a total transmission rank, a per member rank constraint, or a power allocation of data streams of the MU-MIMO data transmission.

15. The method of claim 13, wherein the MU-MIMO parameter set indicates:
whether an MU-MIMO specific Channel Quality Indicator (COI) computation is to be used by the potential member during the link adaptation phase;
if the MU-MIMO specific CQI computation is to be used by the potential member, a CQI computation method for the MU-MIMO specific CQI computation;
whether an MU-MIMO specific Precoding Matrix Indicator (PMI) computation is to be used by the potential member during the link adaptation phase; and
if the MU-MIMO specific PMI computation is to be used by the potential member, a PMI computation method for the MU-MIMO specific PMI computation.

16. The method of claim 13, wherein the MU-MIMO parameter set indicates a total transmission rank, a rank for the potential member, a power allocation of data streams of the MU-MIMO data transmission, or a precoder codebook subset restriction for Precoding Matrix Indicator (PMI) computation by the potential member during the link adaptation phase.

17. The method of claim 13, further comprising:
identifying a member group for the MU-MIMO data transmission; and
if the potential member belongs to the identified member group,
signaling to the potential member, during the MU-MIMO data transmission, an antenna port associated with a reference signal or a modulation scheme of another member of the identified member group.

18. A User Equipment (UE), comprising:
a memory that stores instructions; and
processor circuitry configured, by executing the instructions, to:
receive a Multi-User Multiple Input Multiple Output (MU-MIMO) parameter set associated with a MU-MIMO data transmission;
compute a Channel Quality Indicator (CQI) and a Precoding Matrix Indicator (PMI) in accordance with the MU-MIMO parameter set; and
signal the CQI and PMI to a network entity.

19. The UE of claim 18, wherein the processor circuitry is further configured to:
compute the CQI in accordance with an MU-MIMO specific COI computation method indicated by the MU-MIMO parameter set.

20. The UE of claim 18, wherein the processor circuitry is further configured to:
compute the PMI in accordance with an MU-MIMO specific PMI computation method or a precoder codebook subset restriction indicated by the MU-MIMO parameter set.

21. The UE of claim 18, wherein the processor circuitry is further configured to:
receive, during the MU-MIMO data transmission, an antenna port associated with a reference signal or a modulation scheme of a member of the MU-MIMO data transmission; and
use the antenna port or the modulation scheme to estimate intra-cell interference due to the member in the MU-MIMO data transmission.
